(19) United States
(12) Patent Application Publication
(10) Pub. No.: US 2015/0044400 A1
(43) Pub. Date: Feb. 12, 2015

(54) INSULATING METHOD AND PRODUCT

(71) Applicant: Yick Lap Li, Tseung Kwan O (HK)

(72) Inventor: Yick Lap Li, Tseung Kwan O (HK)

(21) Appl. No.: 13/962,513

(22) Filed: Aug. 8, 2013

(51) Int. Cl. B32B 3/04

(52) U.S. Cl. CPC B32B 3/04
USPC 428/34.1; 29/428

(57) ABSTRACT

An insulating product and method for its creation involving the creation of valve strips with pockets located in the tubes created in the sewn-through construction process.

### BACKGROUND

Down is a very light weight natural material, known to provide exceptional warmth and comfort as insulation material for various products. Product such as down jacket, sleeping bags and household blankets are very well received among consumers. The physical nature of down is fluid-like in which it does not restrict to any shape or form. Its appearance is totally up to the container that holds it.

In constructing a down product, the basic idea is to create a compartment of empty space, to fill it with down content, and subsequently to close the fill hole. There are two commonly used constructions for down products:
Sewn-Through Construction—This is a very simple construction, very commonly found in light weight products like down jackets or down blanket in home bedding. The basic construction is very simple: stitching two pieces of fabrics together to create a series of compartment “tunnels” and then fill it with down content.
Box Baffle Construction—Box Baffle construction is very similar to Sewn-Through construction, the only difference is the addition of a partition material called “baffle mesh”. The baffle mesh sits between the two fabrics and provides a “height” factor to the down compartment. The “height” increases the volume of space, allows more down to be filled and thus provides better warmth. As a result, this construction is mostly suited for performance oriented product like camping equipment, i.e., expedition down jackets and sleeping bags.

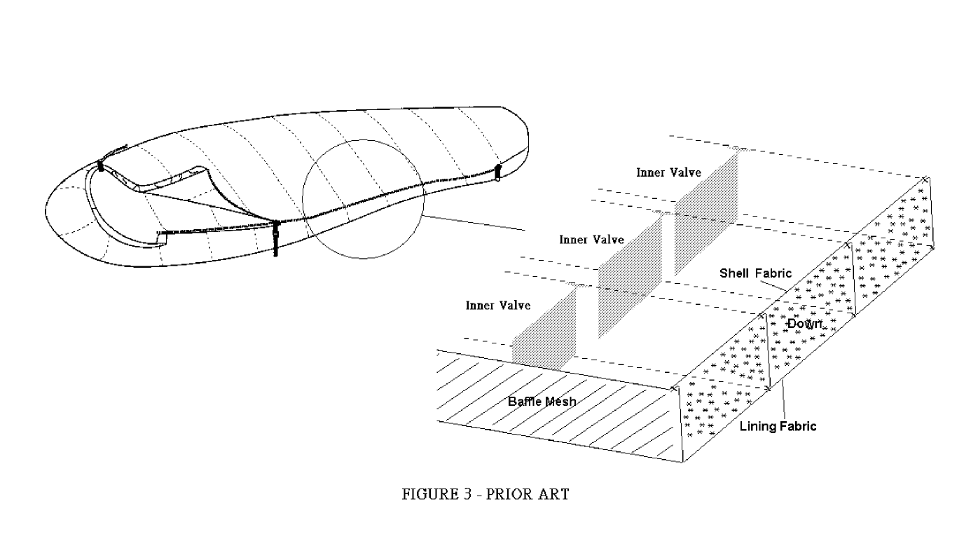

The idea behind the above two constructions is to create a “hollow tube” and have the down to fill up the volume inside. One common problem with down product is, down is a free-flowing, fluid-like material as such it is subject to “down shifting”. “Down shifting” refers to the fact that the down has a tendency to shift around due to external pressure or density variance. If a product is not filled properly, this leads to possible down shifting and thus results in uneven coverage across an area of space. One way to prevent this problem is through the use of a construction technique utilizing inner valves as shown in FIG. 3 (U.S. Pat. No. 7,818,834 and other related prior art).

The inner valves create obstruction inside the hollow tube to reduce the down movement inside. This has proven to be a very effective technique in which it opens up new design possibility such as vertical baffling. All of the current said techniques are intended for Box Baffle Construction, but not applicable to Sewn-Through Construction. Part of the reasons is that Sewn-Through Construction is a 2 dimensional construction where it lacks the volume/footing to install any obstruction/VIV inside. A common way to address this problem is simply applying cross quilting to contain the down in the form of a confined “pockets”.

There are a lot of down jackets in the market today employing such technique. The problem with this construction is, the more the quilt lines, the more the cold spots generated (cold air going in through the quilting lines) and also leads to a higher risk of down leaking through the quilting needle holes. Technically speaking, compared to Baffle Construction, there is no effective way in controlling the down movement in Sewn-Through Construction.

### SUMMARY

A design for the creation of pockets added to the hollow tubes created in sewn through construction provides obstructions to reduce the movement of insulation. The insulation may be down or other material such as synthetic fibers.

The essence of the new construction is the creation of pockets through installing valve strip in each hollow tube and securing it along each stitching/quilting line.
Compared with normal Sewn-Through Construction, by controlling the size and frequency of the valve strip with pockets, one can easily trap the down inside the pockets and thus limit the down movement inside compartment tunnel.
With the valve strip located between fabrics, it reduces the need of cross quilting, leads to fewer cold spots and less down leaking through needle holes.
Pockets create a new opportunity in product design where vertical baffling is now possible in Sewn-Through Construction.

### DETAILED DESCRIPTION OF DRAWINGS

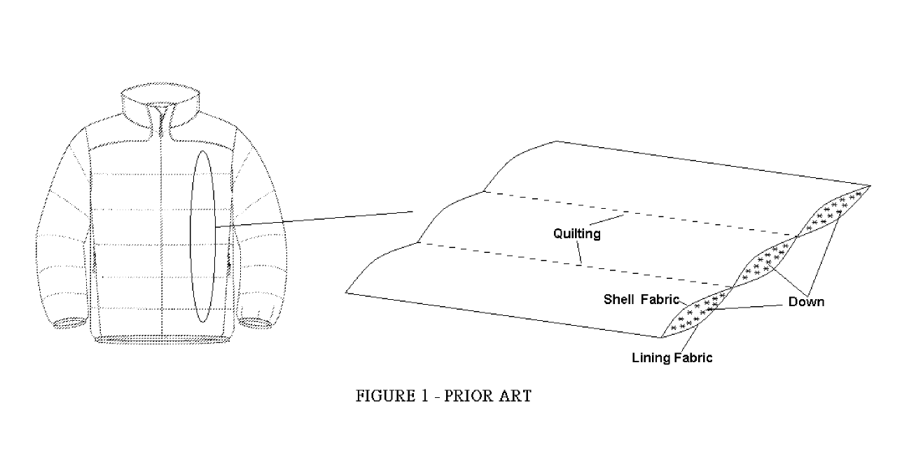

FIG. 1 depicts a typical existing sewn-through construction.

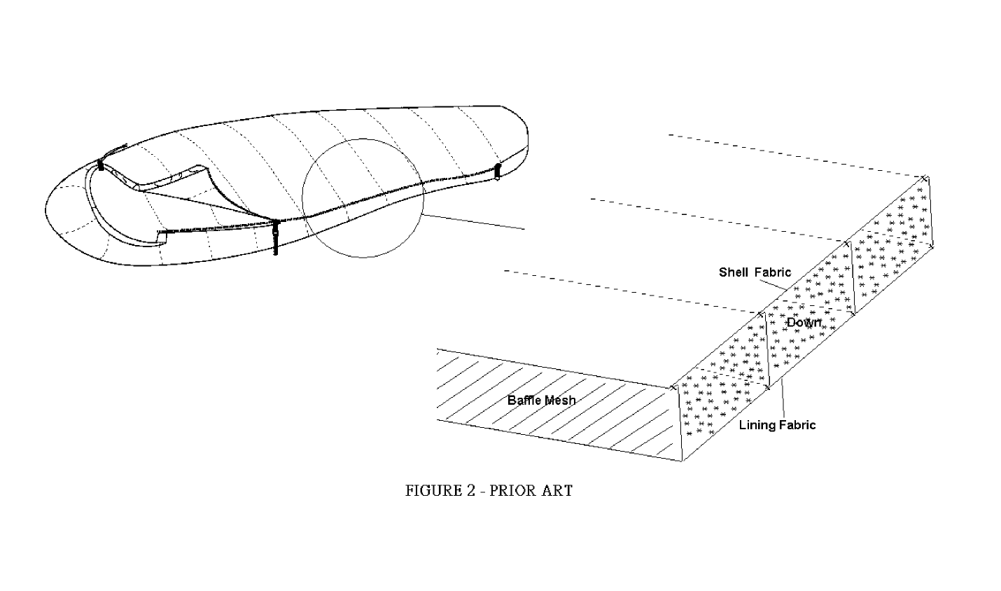

FIG. 2 depicts a typical existing box baffle construction.

FIG. 3 depicts a typical existing box baffle construction with inner valves.

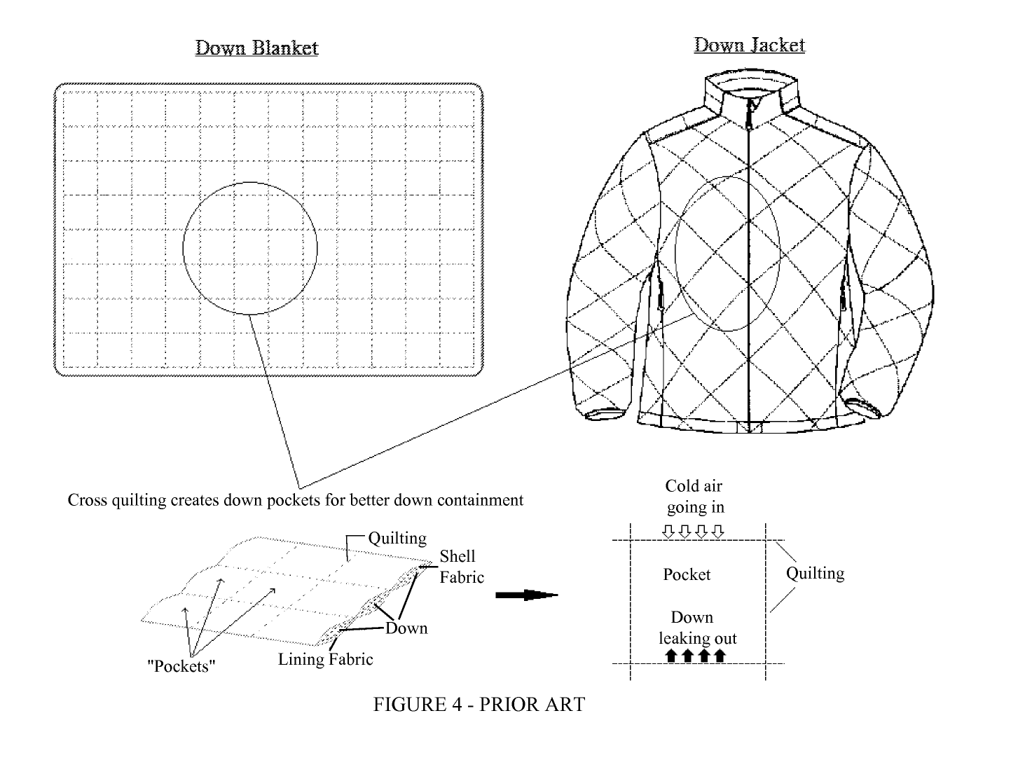

FIG. 4 depicts a typical existing cross quilting construction.

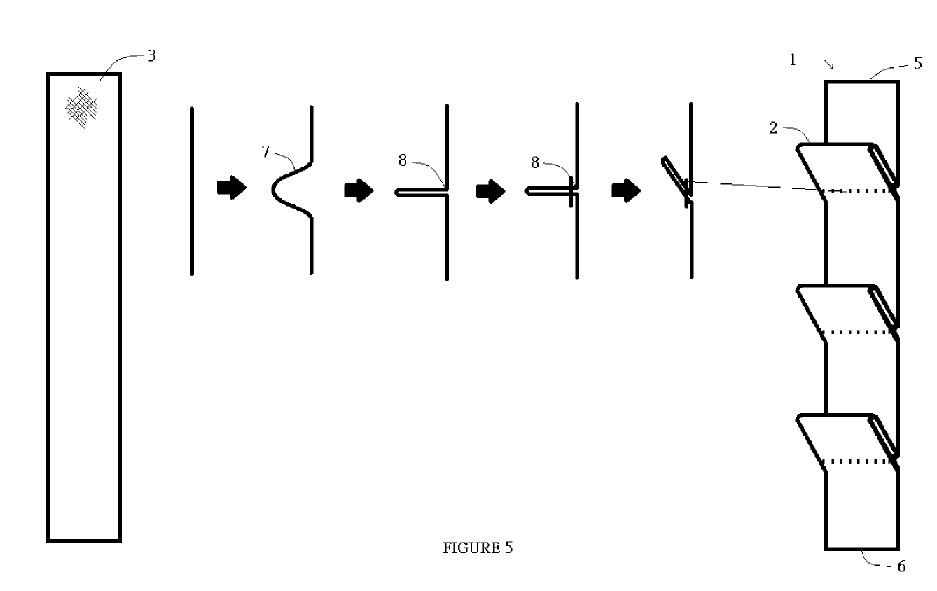

FIG. 5 depicts pockets being formed on a strip to create a valve strip.

FIG. 6 depicts a valve strip for use in two adjacent hollow tubes.

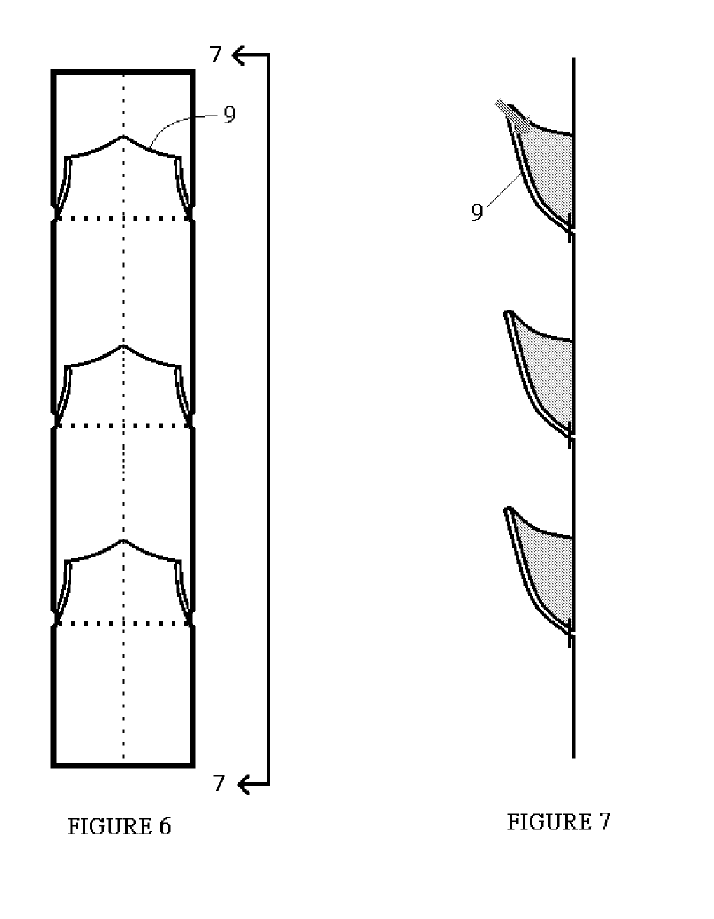

FIG. 7 is a cross section of FIG. 6.

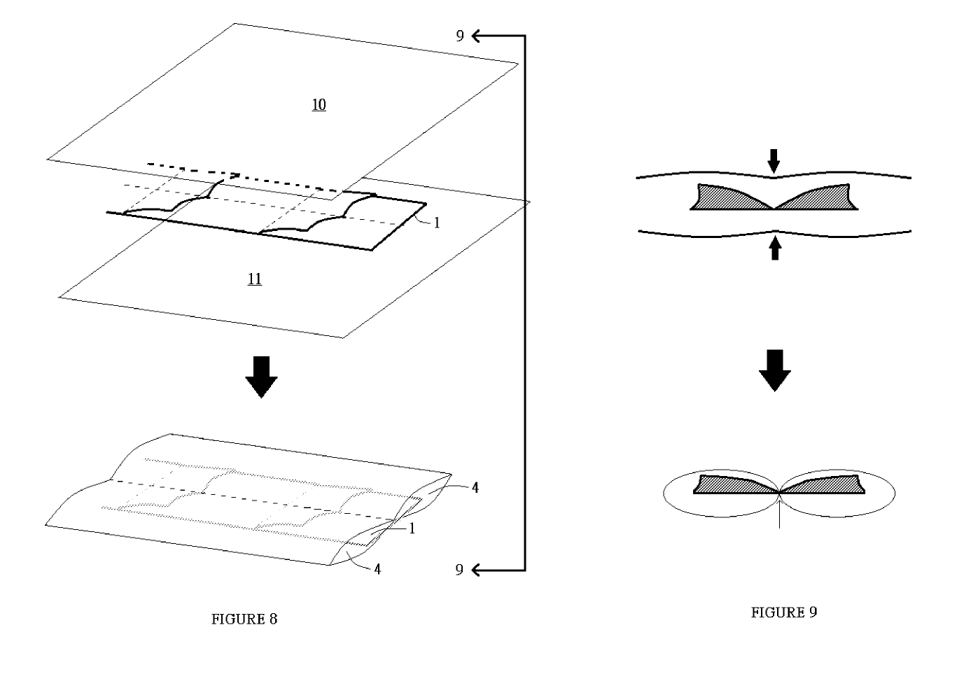

FIG. 8 depicts a valve strip placed between outer shell and inner lining and joined together creating hollow tubes with valve strips inside.

FIG. 9 is a cross section of FIG. 8.

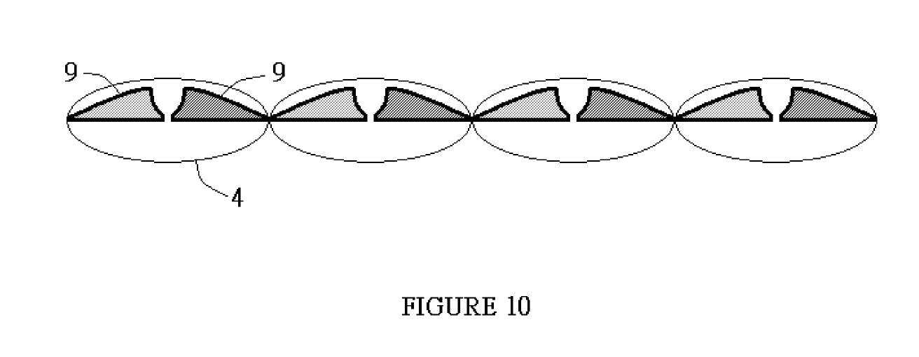

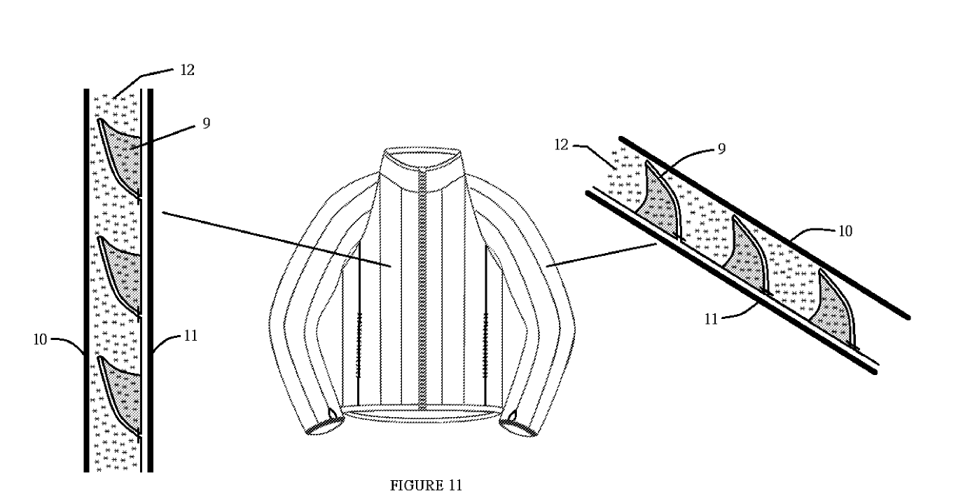

FIG. 10 depicts two valve strips in each hollow tube.

FIG. 11 depicts hollow tubes with valve strip and pockets used in clothing.

### DETAILED DESCRIPTION

In order to impede the movement of insulation in sewn through construction, pockets (9) are created in the hollow tubes (4). The pockets (9) are created on valve strips (1) added to hollow tubes (4) during the sewn through construction process. One method to create valve strips (1) is depicted in FIG. 5. Flaps (2) are created by folding material strips (3) as shown on FIG. 5. The size of the material strips (3) and the number of flaps (2) varies based on the intended application.

The strips (3) have a width less than the width of hollow tubes for which it is intended and an appropriate length for the intended hollow tube (4). Each strip (3) has a forward end (5) and a rear end (6). Each flap (2) is created by pinching a section of the material together (7). The two layers created by pinching are attached to each other at their base (8) or origin point on the strip (3). All the flaps (2) on a valve strip (1) are folded toward the forward end (5) of the strip (3) creating a valve strip (1).

A valve strip (1) can be designed to create pockets (9) in a single hollow tube (4) or two adjacent hollow tubes. A valve strip (1) for a single hollow tube has one side of the flaps (2) attached longitudinally to the valve strip (1). A valve strip (5) designed for use in two adjacent hollow tubes has the middle section of each flap (2) attached longitudinally to the valve strip (1).

The valve strip is placed between the outer shell fabric (10) and inner lining fabric (11). The outer shell (10) and inner fabric (11) are then joined longitudinally to each other and to the inner valve between them, thereby creating the hollow tubes with valve strips. Insulation is added in the hollow tubes (4) and its pockets (9).

Any material can be used for the strips but baffle mesh as used in box baffle constructions is best for most applications. Stitching is the best means to join/attach the materials as required (attachment of two layers of the pinched flap to each other at their base; longitudinal attachment of the flaps to the valve strips; and joining of outer shell to inner fabric to each other with valve strip between them). Other methods for joining the materials known to those in the field of creating insulation products may also be used such as an adhesive. The insulation (12) can be down, synthetic fibers or other material as appropriate for a particular application.

In another embodiment two valve strips are placed in each hollow tube as shown on FIG. 10. In this embodiment the pockets attached to the left side of the hollow tube can be located directly across from the pockets attached to the right side of the hollow tube i.e. the same distance from the forward edge (5) of the valve strip. Or each of the left side pockets can be positioned to be in between two pockets on the right side of the tube i.e. different distances from the forward edge (5) of the valve strip.

The embodiments disclosed can be used in the construction of clothing, sleeping bags, thermal bags, blankets and other applications requiring insulation.

The above illustrates various concepts, structures and techniques which are the subject of this patent. It will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

I claim:

1. An insulating product comprising:
an outer shell; an inner lining;
a valve strip with at least one pocket;
the valve strip positioned on the inner lining;
at least one tube created by the attachment of the outer shell to the valve strip and the inner lining with the valve strip between the outer shell and the inner lining ; and
insulation installed each tube.

2. An insulating product according to claim 1 wherein the at least one pocket on the valve strip comprises a section of a material strip which has a front end and a rear end, pinched to form a flap with layers of the flap attached to each other at a base of the flap on the material strip; wherein all flaps are folded towards the front end of the material strip and a side of all flaps attached longitudinally to the valve strip.

3. An insulating product according to claim 2 wherein the insulating product includes multiple tubes each constructed with at least one valve strip with multiple pockets.

4. An insulating product according to claim 3 wherein in each tube includes two valve strips with one valve strip positioned on the left side of the tube and a second valve strip positioned on a right side of the tube.

5. An insulating product according to claim 1 wherein the at least one pocket on the valve strip comprises a section of a material strip which has a front end and a rear end pinched to form a flap with layers of the flap attached to each other at a base of the flap at the material strip; wherein all flaps are folded towards the front end of the material strip and a middle section of all flaps attached longitudinally to the valve strip with a pocket formed on each side of the middle section; and the valve strip positioned such that the pocket formed on the left side of the middle section is in one tube and the pocket formed on the right side of the middle section is in an adjacent tube.

6. An insulating product according to claim 5 wherein the insulating product includes multiple tubes each with multiple valve strips and each valve strip with multiple pockets.

7. An insulating product according to claim 5 wherein in each tube includes the pockets on one valve strip positioned on the left side of the tube and the pockets on a second valve strip positioned on a right side of the tube.

8. A method for creating an insulating product comprising:
creating an outer shell; creating an inner lining;
selecting a strip of material with a front end and a rear end;
creating at least one pocket on at least one valve strip by forming at least one flap on the strip of material by pinching a section of material together; attaching the two layers of the flap to each other at the base of the flap on the strip of material;
folding all flaps toward the front end the strip of material;
attaching one side of all flaps longitudinally to the strip of material;
placing the valve strip on the inner lining;
attaching the outer shell to the valve strip and to the inner lining forming a tube with the valve strip between the outer shell and the inner lining; and
installing insulation.

9. A method for creating an insulating product according to claim 8 wherein the flaps on the valve strip are attached to the strip material at a middle section of the flaps on the strip creating a pocket to the left of the middle section and a second pocket to the right of the middle section and positioning the valve strip on the inner lining such that the pocket to the left of the middle section is in one tube in the pocket to write up the middle section is in an adjacent tube.

10. A method for creating an insulating product according to claim 9 wherein the insulating product includes multiple tubes each constructed with at least one valve strip with multiple pockets.

11. A method for creating an insulating product according to claim 10 wherein in each tube includes two valve strips with one valve strip positioned on the left side of the tube and a second valve strip positioned on a right side of the tube.

12. A method for creating an insulating product according to claim 8 wherein the insulating product includes multiple tubes each constructed with at least one valve strip with multiple pockets.

13. A method for creating an insulating product according to claim 12 wherein in each tube includes two valve strips with one valve strip positioned on the left side of the tube and a second valve strip positioned on a right side of the tube.
